(19) United States
(12) Patent Application Publication
(10) Pub. No.: US 2009/0237690 A1
(43) Pub. Date: Sep. 24, 2009

(54) IMAGE PROCESSING APPARATUS, IMAGE PROCESSING METHOD, AND IMAGE FORMING APPARATUS

(75) Inventor: Hiroki Umezawa, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/401,681

(22) Filed: Mar. 11, 2009

Related U.S. Application Data
(60) Provisional application No. 61/037,570, filed on Mar. 18, 2008.

(51) Int. Cl. G06F 15/00

(52) U.S. Cl. 358/1.9

(57) ABSTRACT

An image processing apparatus reconfigured image fragments received from a host, by using an image block selector 101 that generates a layout list of image fragments constituting an image before division for each image before division and an image block composer 102 that reconfigures the image before division in accordance with the layout list outputted from the image block selector 101. After that, the image processing apparatus performs correction such as luminance correct and white balance correction.

### CROSS-REFERENCE TO RELATED APPLICATION

This application is based upon and claims the benefit of priority from the prior U.S. Patent Application No. 61/037,570, filed on 18 Mar. 2008, the entire contents of which are incorporated herein by reference.

### TECHNICAL FIELD

The present invention relates to an image forming apparatus such as a printer, and particularly to an image processing apparatus and an image forming method for printing an image obtained by correcting an image transmitted from a host such as a computer, and an image forming apparatus using these apparatus and method.

### BACKGROUND

Conventionally, if there is only one original image, only one image is supplied from a host such as a computer to an image forming apparatus such as a printer. The image forming apparatus performs the following image processing to form a more beautiful image.

For example, an image as shown in FIG. 19 transmitted by the host has a luminance histogram as shown in FIG. 20. In FIG. 20, the horizontal axis represents luminance and the vertical axis represents the number of units of pixels. As shown in FIG. 20, luminance spreads in a limited range from A to B.

The image forming apparatus corrects input luminance by using a conversion function as shown in FIG. 21. In FIG. 21, the horizontal axis represents input luminance and the vertical axis represents output luminance. The output result is as shown in FIG. 22. In FIG. 22, the horizontal axis represents luminance and the vertical axis represents the number of units of pixels. As shown in FIG. 22, bright parts become brighter and dark parts become darker, thus forming a beautiful image with high contrast.

For the correction, for example, JP-A-2003-46778 and JP-A-8-138043 disclose correction methods.

However, recently, in consideration of data transfer capacity, the host may divide one image into plural image parts and output each image part as a separate file to the image forming apparatus. For example, the image of FIG. 19 may be divided into three image fragments, that is, a first image fragment 2301, a second image fragment 2302 and a third image fragment 2303, as shown in FIG. 23.

According to the conventional techniques, since the image fragments have different luminance histograms from each other, the output result of respective image fragments may differ in tone, causing a problem that a beautiful image cannot be formed.

### SUMMARY

It is an object of the invention to provide an image processing apparatus and an image processing method that enable correction of an image even if a host transmits a divided image, and an image forming apparatus using these apparatus and method.

It is another object of the invention to provide an image processing apparatus which performs image correction after reconfiguring an image divided and transmitted by a host.

According to an aspect of the invention, an image processing apparatus includes: an image block selector that receives print data including an image fragment read out of an image equivalent to one page, and generates a layout list showing a layout of the image fragment for each image before division; an image block composer that reconfigures an image before the division in accordance with the layout list; an image characteristic extractor that generates a luminance histogram of the reconfigured image before the division; and an image processor that corrects the histogram, thereby corrects the image before the division and outputs the corrected image.

### DESCRIPTION OF THE DRAWINGS

FIG. 1 is a view showing a hardware configuration of an image processing apparatus according to a first embodiment.

FIG. 2 is a flowchart showing an outline of processing in the image processing apparatus according to the first embodiment.

FIG. 3 is a block diagram showing a software module for image block selection control carried out by the image processing apparatus according to the first embodiment.

FIG. 4 is a view showing exemplary image fragments equivalent to one page transmitted from a host.

FIG. 5 is a flowchart showing an operation to generate a layout list in the image processing apparatus.

FIG. 6 is a view showing two image fragments vertically neighboring to each other.

FIG. 7 shows distribution of the number of units of D-value used for calculating a threshold value T.

FIG. 8 shows an exemplary layout list outputted by the image processing apparatus using an image block selector.

FIG. 9 is a view showing a first example of a coupled image outputted by the image processing apparatus using an image block composer.

FIG. 10 is a view showing a second example of a coupled image outputted by the image processing apparatus using the image block composer.

FIG. 11 is a block diagram showing a software module for image block selection control carried out by an image processing apparatus according to a second embodiment.

FIG. 12 is a view showing an example of attribute data.

FIG. 13 is a view showing position information in a page.

FIG. 14 is a flowchart showing an operation to generate a layout list in the image processing apparatus.

FIG. 15 is a block diagram showing a software module for image block selection control carried out by an image processing apparatus according to a third embodiment.

FIG. 16 is a view showing a color solid at a highlight point.

FIG. 17 is a view showing a color solid representing white.

FIG. 18 is a block diagram showing a software module for image block selection control carried out by an image processing apparatus according to a fourth embodiment.

FIG. 19 is a view showing an exemplary image transmitted by a host.

FIG. 20 is a view showing a luminance histogram of an image transmitted from a host.

FIG. 21 is a view showing a conversion function.

FIG. 22 is a view showing a luminance histogram after conversion.

FIG. 23 is a view showing an image divided and transmitted by a host.

### DETAILED DESCRIPTION

Throughout this description, the embodiments and examples shown should be considered as exemplars, rather than limitations on the apparatus and methods of the invention.

Hereinafter, an embodiment of an image processing apparatus, an image processing method and an image forming apparatus will be described in detail with reference to the drawings. An image processing apparatus can be used for an image forming apparatus such as a printer.

### First Embodiment

### (Outline of Configuration)

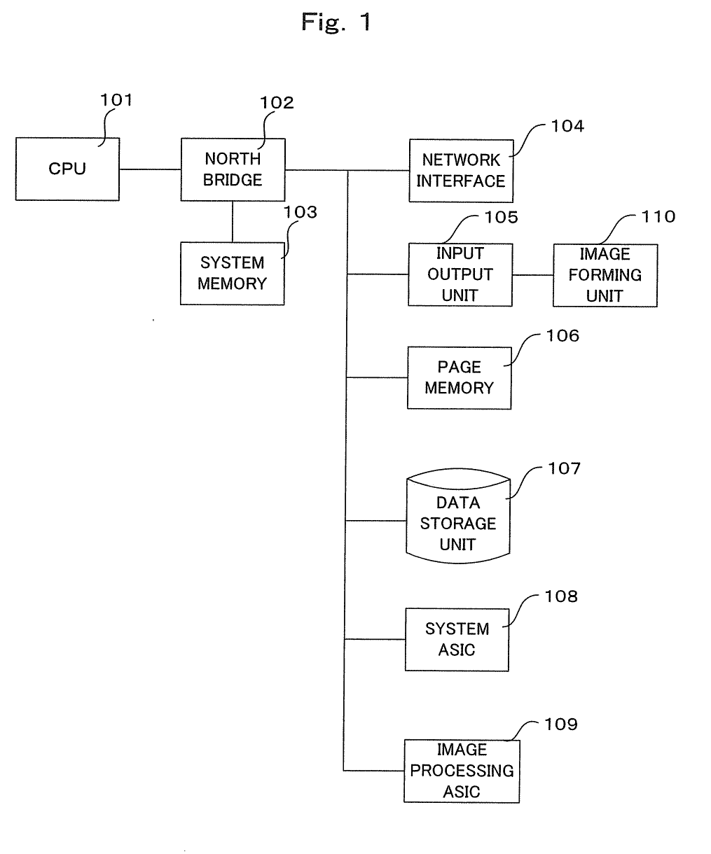

FIG. 1 is a view showing a hardware configuration of an image processing apparatus. As shown in FIG. 1, the image processing apparatus has a CPU 101 as an operating unit, a north bridge 102 connected to the CPU 101, and a system memory 103 connected to the north bridge 102. The north bridge 102 refers to an LSI that controls distribution of information in the image processing apparatus.

A network interface 104, an input output unit 105, a page memory 106, a data storage unit 107, a system ASIC 108, and an image processing ASIC 109 as an ASIC which performs image processing, are connected to the north bridge 102.

The input output unit 105 sends image data to an image forming unit 110. The image forming unit 110 forms an image based on the received image data.

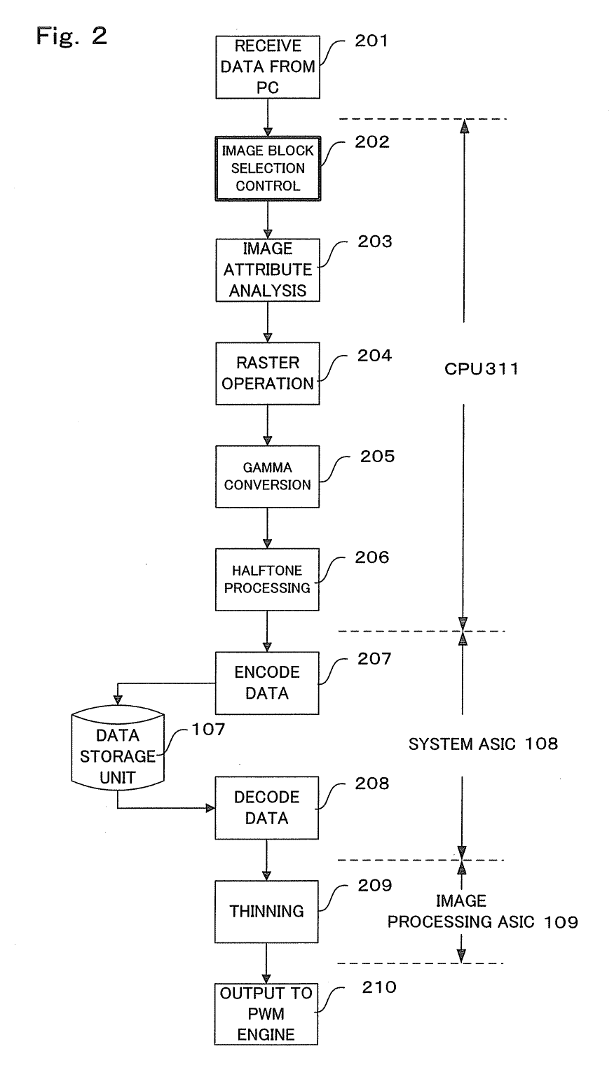

FIG. 2 is a flowchart showing an outline of processing in the image processing apparatus. As shown in FIG. 2, in Act 201, the image processing apparatus receives data to be printed from a host such as a personal computer.

In Act 202, the image processing apparatus executes image block selection control to reconfigure each image (hereinafter referred to as image fragment) obtained by division of one image (original image) and transmitted by the host, and to perform image processing such as luminance correction.

If the host divides one image and transmits the divided image to the image forming apparatus, in order to perform correction, the image processing apparatus needs to determine which of the randomly transmitted images from the host originally constitutes one image, because correction must be performed for each one image before division.

In the first embodiment, images constituting the image before division and the position of the images constituting the image before division are determined in accordance with the size and luminance of the divided images.

In Act 203, the image processing apparatus performs image attribute analysis and classifies data to be printed into text, graphics, and photo. The image processing apparatus performs raster operation in Act 204, gamma conversion in Act 205, and halftone processing in Act 206.

The CPU 101 carries out the processing of Acts 202 to 206 by using software.

In Act 207, the image processing apparatus encodes data and sequentially stores the data into the data storage unit 107. In Act 208, the image processing device sequentially reads out and decodes the stored data. The system ASIC 108 carries out the processing of Acts 207 and 208.

The image processing apparatus performs thinning in Act 209 and outputs thinned data to a PWM engine in Act 210. The image processing ASIC 109 carries out the processing of Act 209. The PWM engine may constitute the image forming unit 110.

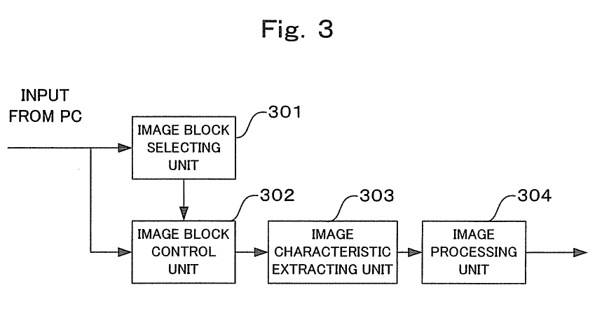

FIG. 3 is a block diagram showing a software module for image block selection control carried out by the image processing apparatus. As shown in FIG. 3, the image processing apparatus has an image block selector 301 that receives image fragments equivalent to one page inputted from a host such as a personal computer and generates a layout list showing a layout of image fragments constituting an image before division for each image before division, an image block composer 302 that receives the image fragments inputted from the host and reconfigures the image before division in accordance with the layout list outputted from the image block selector 301, an image characteristic extractor 303 that generates a luminance histogram of the reconfigured image before division, and an image processor 304 that corrects the generated histogram, thereby corrects the image before division, and outputs the corrected image.

### (Image Block Selector)

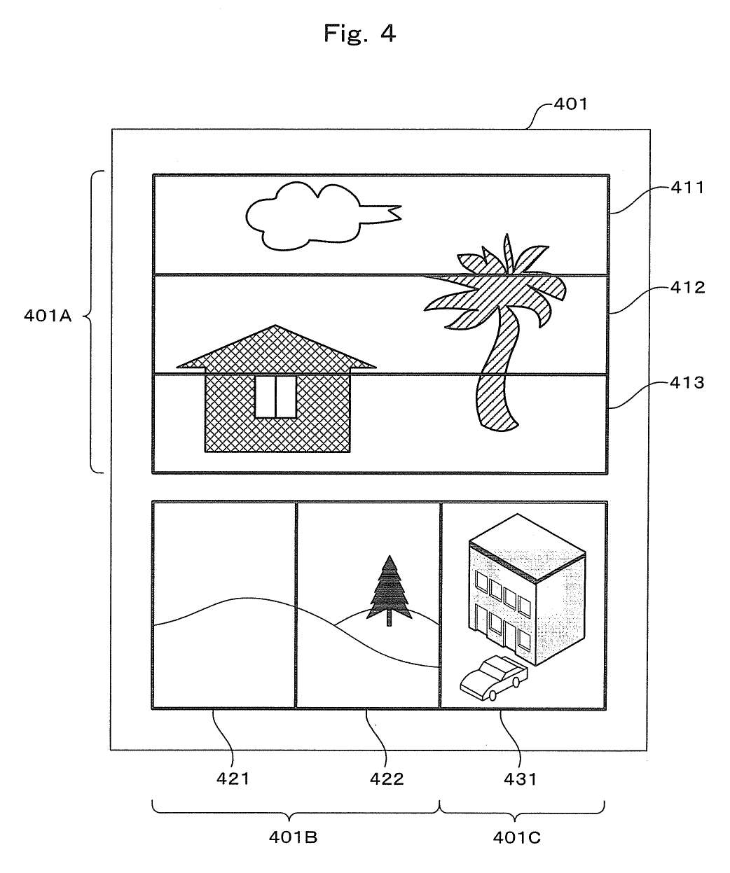

FIG. 4 is a view showing exemplary image fragments equivalent to one page transmitted from the host. There are three images 401A, 401B and 401C before division in a page 401 to be printed. The host divides the image 401A into a first image fragment 411, a second image fragment 412 and a third image fragment 413.

The host divides the image 401B into a fourth image fragment 421 and a fifth image fragment 422. The host does not divide the image 401C. The image processing apparatus handles the image that is not divided by the host, as one image fragment.

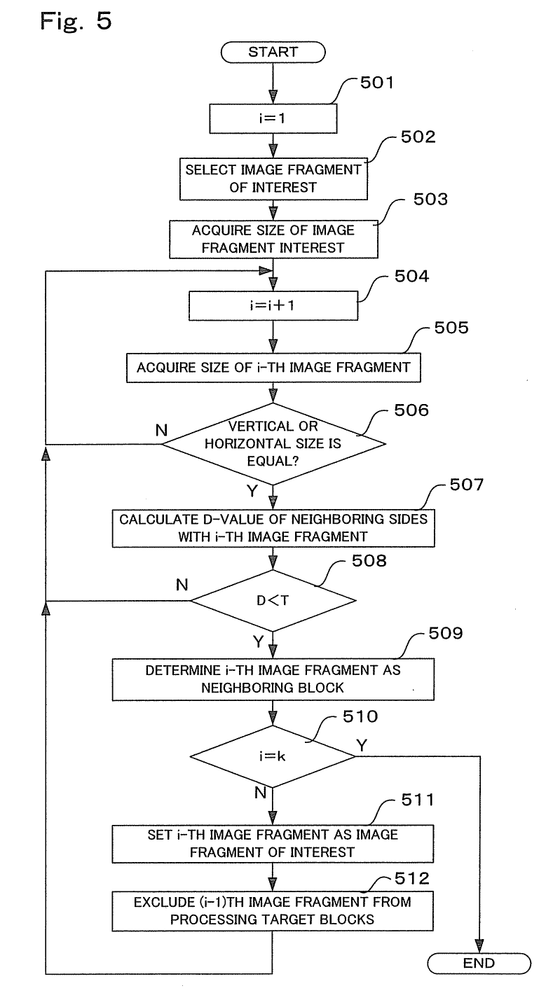

The image processing apparatus generates a layout list by using the image block selector 301. FIG. 5 is a flowchart showing the operation to generate a layout list in the image processing apparatus.

As shown in FIG. 5, in Act 501, the image processing apparatus initializes a counter i with 1. If the host does not give titles to image fragments, the image processing apparatus gives titles to image fragments.

The image processing apparatus names the first image fragment 411 image block 1, the second image fragment 412 image block 2, the third image fragment 413 image block 3, the fourth image fragment 421 image block 4, the fifth image fragment 422 image block 5, and the sixth image fragment 431 image block 6.

In Act 502, the image processing apparatus selects one image fragment, as an image fragment of interest, from the image fragments equivalent to one page. The selection technique may be in input order or in random order.

In Act 503, the image processing apparatus acquires the size of the image fragment of interest. To define the size of the image fragment of interest, the number of pixels in the horizontal direction is counted and the number of pixels in the horizontal direction is used as the horizontal size, and the number of pixels in the vertical direction is counted and the number of pixels in the vertical direction is used as the vertical size.

In Act 504, the image processing apparatus adds 1 to the counter i and assumes the result of the addition as a new i value. In Act 505, the image processing apparatus acquires the size of the i-th image fragment by the technique described in Act 503.

In Act 506, the image processing apparatus compares the size of the image fragment of interest and the size of the i-th image fragment. If the vertical or horizontal size is equal, the image processing apparatus goes to Act 507. If not, the image processing apparatus returns to Act 504.

In Act 507, the image processing apparatus calculates a D-value of the neighboring sides of the image fragment of interest and the i-th image fragment. A D-value refers to a numeric value representing the degree of difference in color between two neighboring pixels. The method of calculating the D-value will be described later.

In Act 508, the image processing apparatus determines whether the D-value is smaller than a threshold value T. If the D-value is smaller than the threshold value, the two pixels are so similar in color that the two pixels can be regarded as neighboring to each other in the image before division. In Act 509, if the D-value is smaller than the threshold value, the image processing apparatus determines the i-th image fragment as a neighboring image to the image fragment of interest.

The image processing apparatus allocates “A1” as position information to the image fragment of interest. Then, if the i-th image fragment is situated below the image fragment of interest, the image processing apparatus allocates “A2” as position information to the i-th image fragment.

If the i-th image fragment is situated to the right of the image fragment of interest, the image processing apparatus allocates “B1” as position information to the i-th image fragment.

If the i-th image fragment is situated below the image fragment of interest, the image processing apparatus sequentially increases the number on the right as in “A2” and “A3” as position information allocated to the i-th image fragment. Meanwhile, if the i-th image fragment is situated to the right of the image fragment of interest, the image processing apparatus sequentially advances the alphabetic letter on the left as in “B1” and “C1” as position information allocated to the i-th image fragment. If the D-value is equal to or greater than the threshold value, the image processing apparatus returns to Act 504.

If the i-th image fragment is situated above or to the left of the image fragment of interest, the i-th image fragment is regarded as the image fragment of interest. The count value i=1 is taken and the processing is executed again from Act 503.

In Act 510, the image processing apparatus determines whether the counter i reaches the total number of image fragments k. If the counter i reaches the total number of image fragments k, the image processing apparatus allocates a coupled image title, which is a title if the image fragments are reconfigured, to a group of image fragments determined as neighboring to each other, and then ends the processing. If the total number of image fragments k is not reached, the image processing apparatus goes to Act 511.

In Act 511, the image processing apparatus sets the i-th image fragment as an image fragment of interest. In Act 512, the image processing apparatus excludes the (i−1)th image fragment from processing targets and raises a flag associating the (i−1)th image fragment. Then, the image processing apparatus returns to Act 504.

The image processing apparatus repeats the above processing of Act 501 to Act 512 until there is no determination target image fragments left for each coupled image.

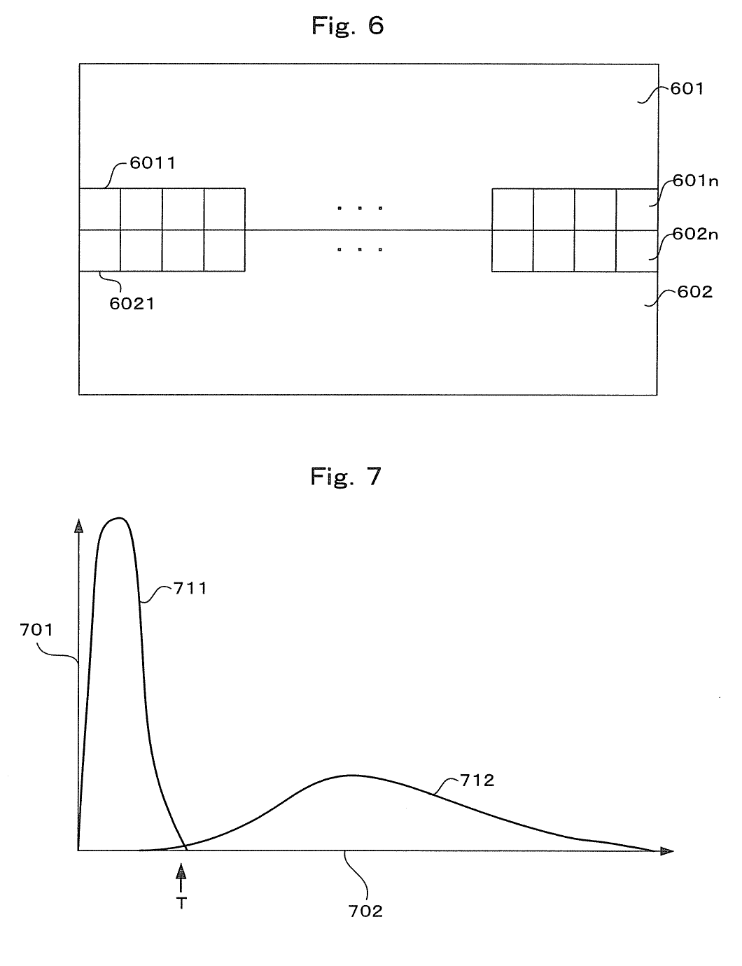

The method of calculating the D-value will be explained. FIG. 6 is a view showing two image fragments vertically neighboring to each other. The case of determining whether an i-th image fragment 602 is neighboring and below an image fragment of interest 601 will be described. The image processing apparatus randomly selects neighboring pixels on the neighboring sides of the two image fragments. For example, a pixel 6011 and a pixel 6021 are neighboring each other. Also, a pixel 601n and a pixel 602n are neighboring each other.

If each of the two image fragments includes a color image, the image processing apparatus calculates the D-value as in the following equation (1), for example, by using a Euclidean distance.

$$D = \frac{{\sum }_{p = 1}^{N} \sqrt{{( {R}_{1 p} - {R}_{2 p} )}^{2} + {( {G}_{1 p} - {G}_{2 p} )}^{2} + {( {B}_{1 p} - {B}_{2 p} )}^{2}}}{N} \qquad ( 1 )$$

N represents the number of sets of selected neighboring pixels. R, G and B represent gradation of pixels in the RGB format. The subscript “1” on the left of R, G and B represents a pixel in the image fragment of interest 601, and “2” represents a pixel in the i-th image fragment 602.

If the two image fragments are of gray scale, the image processing apparatus calculates the D-value as in the following equation (2), for example, by using a Euclidean distance.

$$D = \frac{{\sum }_{p = 1}^{N} \sqrt{{( {I}_{1 p} - {I}_{2 p} )}^{2}}}{N} \qquad ( 2 )$$

I represents gradation of a pixel of gray scale. The subscript “1” on the left of I represents a pixel in the image fragment of interest 601, and “2” represents a pixel in the i-th image fragment 602.

FIG. 7 shows distribution of the number of units of D-value used for calculating the threshold value T. The distribution of the number of units of D-value shows D-values in various images in the case of neighboring pixels and in the case of non-neighboring pixels. The horizontal axis 702 represents D-value and the vertical axis 701 represents the number of units.

As shown in FIG. 7, the distribution of the number of units 711 for neighboring pixels has a steep peak at a small D-value. The distribution of the number of units 712 for non-neighboring pixels has a gentle peak at a large D-value.

The threshold value T is set near the boundary between the distribution of the number of units 711 for neighboring pixels and the distribution of the number of units 712 for non-neighboring pixels.

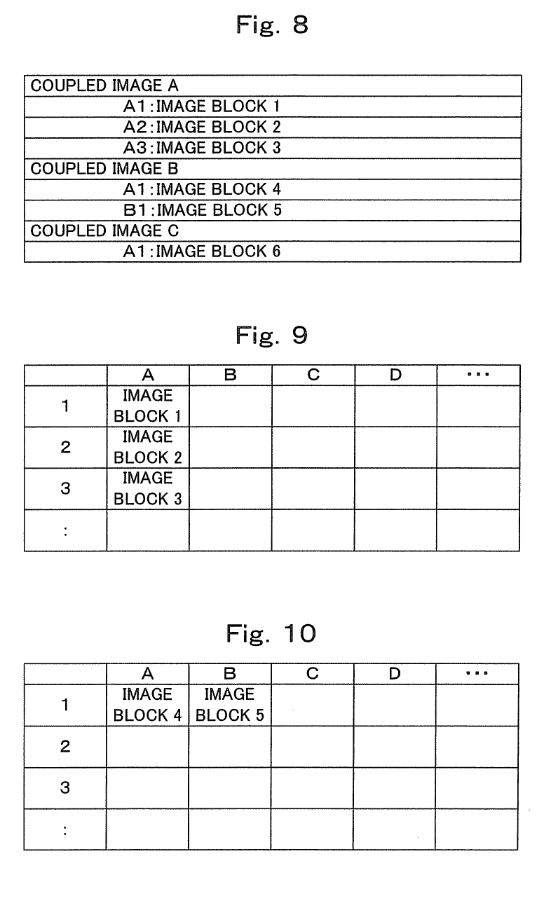

FIG. 8 shows an exemplary layout list outputted by the image processing apparatus using the image block selector 301. As shown in FIG. 8, the layout list includes a coupled image title, position information starting with A1, and title of image fragment, for each coupled image. The layout list may also include other information. The layout of the layout list is not limited to the one shown in FIG. 8.

### (Image Block Composer)

FIG. 9 is a view showing a first example of a coupled image outputted by the image processing apparatus using the image block composer 302. As shown in FIG. 9, the image processing apparatus arranges image fragments inputted from the host, in accordance with the layout list.

Of the position information in the layout list, alphabetic letters show the horizontal layout from left to right, and numerals show the vertical layout from top to bottom.

Since the image block 1 of the coupled image A has position information “A1”, the image processing apparatus arranges the image block 1 at the top left position. Since the image block 2 has position information “A2”, the image processing apparatus arranges the image block 2 below the image block 1. That is, the image blocks are arranged in such a manner that the numeric parts of the position information are arrayed in ascending order from top to bottom in the image processing apparatus. The coupled image A is thus reconfigured.

FIG. 10 is a view showing a second example of a coupled image outputted by the image processing apparatus using the image block composer 302.

Since the image block 4 of the coupled image B has position information “A1”, the image processing apparatus arranges the image block 4 at the top left position. Since the image block 5 has position information “B1”, the image processing apparatus arranges the image block 5 to the right of the image block 4. That is, the image blocks are arranged in such a manner that the letter parts of the position information are in ascending order from left to right in the image processing apparatus. The coupled image B is thus reconfigured.

### (Image Characteristic Extractor and Image Processor)

The image characteristic extractor 303 extracts the characteristic quantity of each coupled image. For example, the image characteristic extractor 303 generates a luminance histogram for each coupled image. The luminance histogram is as shown in FIG. 20, which is already described.

The image processor 304 converts input luminance for each coupled image and outputs the converted luminance. The image processor 304 may convert input luminance by using a conversion function as shown in FIG. 21. The output of the image processor 304 is, for example, as shown in FIG. 22.

As shown in FIG. 22, bright parts become brighter and dark parts become darker, thus forming a beautiful image with high contrast.

The image processing apparatus may reconfigure image fragments received from the host, by using the image block selector 301 that generates a layout list of image fragments forming an image before division, for each image before division, and the image block composer 302 that receives image fragments from the host and reconfigures the image before division in accordance with the layout list outputted from the image block selector 301. The image processing apparatus can form a beautiful image no matter how the host divides an image and transmits the divided image to the image forming apparatus.

### Second Embodiment

### (Outline of Configuration)

In a second embodiment, the outline of the configuration is similar to that of the first embodiment. The second embodiment is different from the first embodiment in the configuration and operation of a software module for image block selection control.

The host may transmit image fragments and data representing attributes such as position information and resolution of the image fragments to the image forming apparatus. In the embodiment, an image before division is reconfigured more efficiently by using the data representing attributes.

An image before division cannot be reconfigured simply in accordance with the position information. If different images are neighboring to each other, the neighboring images cannot be determined as a combination divided from an image.

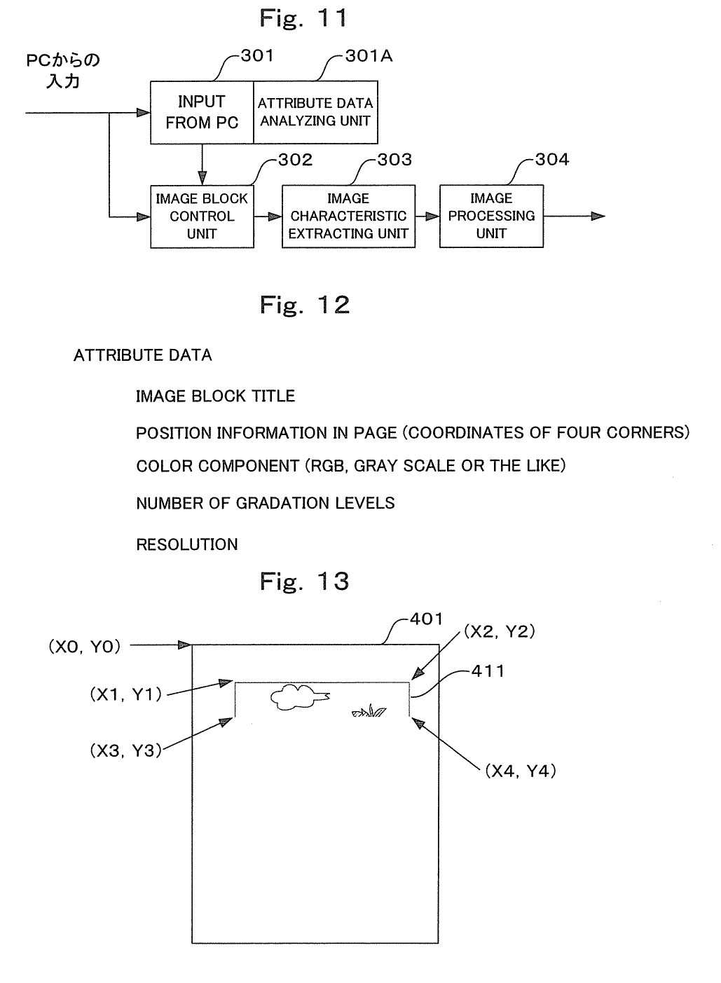

FIG. 11 is a block diagram showing a software module for image block selection control carried out by the image processing apparatus. As shown in FIG. 11, the image processing apparatus has an image block selector 301 that receives image fragments equivalent to one page and attribute data inputted from a host such as a personal computer and generates a layout list of image fragments constituting an image before division for each image before division by using the attribute data, an image block composer 302 that receives the image fragments inputted from the host and reconfigures the image before division in accordance with the layout list outputted from the image block selector 301, an image characteristic extractor 303 that generates a luminance histogram of the reconfigured image before division, and an image processor 304 that corrects the generated histogram, thereby corrects the image before division, and outputs the corrected image.

The image block selector 301 has an attribute data analyzer 301A that analyzes attribute data.

The host may transmit, for each image fragment, attribute data representing attributes of the image fragment.

FIG. 12 is a view showing exemplary attribute data. Attribute data include, for example, image block title that is univocally allocated to each image fragment, position information such as coordinates of the four corners of the image fragment in the page, information about color components such as RGB or gray scale, the number of gradation levels indicating how many levels each color should be divided into, and resolution expressed by dpi or the like.

Some of plural parameters of attribute data may be omitted.

FIG. 13 is a view showing position information in the page. As shown in FIG. 13, the host defines the top left position in a page 401 as the origin (X0, Y0) and transmits position information in the page 401 to the image processing apparatus, defining the coordinates of the four corners of each image fragment as (X1, Y1) to (X4, Y4).

### (Image Block Selector)

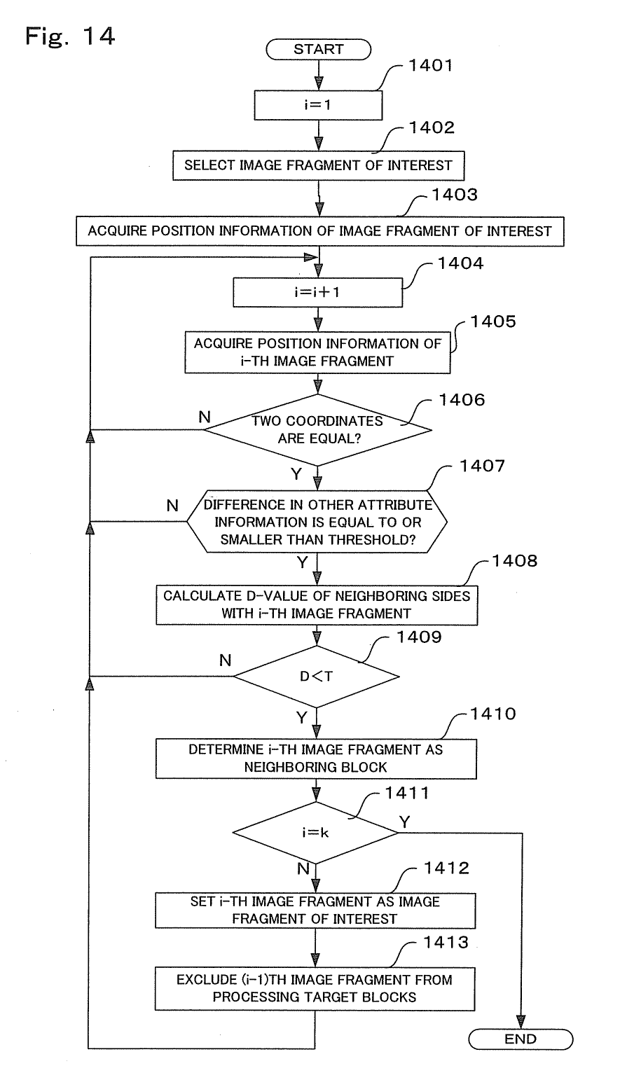

The image processing apparatus generates a layout list by using the image block selector 301. FIG. 14 is a flowchart showing the operation to generate a layout list in the image processing apparatus.

As shown in FIG. 14, in Act 1401, the image processing apparatus initializes the counter i by 1.

It is assumed that titles given by the host are described in attribute data such as image block 1 for a first image fragment 411, image block 2 for a second image fragment 412, image block 3 for a third image fragment 413, image block 4 for a fourth image fragment 421, image block 5 for a fifth image fragment 422, and image block 6 for a sixth image fragment 431.

In Act 1402, the image processing apparatus selects one of image fragments equivalent to one page, as an image fragment of interest. The selection method may be in the input order or in a random order.

In Act 1403, the image processing apparatus acquires position information of the image fragment of interest from the attribute data.

In Act 1404, the image processing apparatus adds 1 to the counter i and assumes the counter i as a new i value. In Act 1405, the image processing apparatus acquires position information of the i-th image fragment from the attribute data.

In Act 1406, the image processing apparatus compares the coordinates of the four corners of the image fragment of interest with the coordinates of the four corners of the i-th image fragment, and determines whether the coordinates of two of the four corners are equal. If the coordinates of two corners are not equal, the image processing apparatus returns to Act 1404.

If the coordinates of two corners are equal, and if the i-th image fragment is situated above the image fragment of interest, that is, if the i-th image fragment has coordinates equal to (X1, Y1) and (X2, Y2) of the image fragment of interest, or if the i-th image fragment is situated to the left of the image fragment of interest, that is, if the i-th image fragment has coordinates equal to (X1, Y1) and (X3, Y3) of the image fragment of interest, the i-th image fragment is regarded as the image fragment of interest. The counter value i=1 is taken and the processing is executed again from Act 1403.

If coordinates of two corners are equal, and if the i-th image fragment is situated below the image fragment of interest, that is, if the i-th image fragment has coordinates equal to (X3, Y3) and (X4, Y4) of the image fragment of interest, or if the i-th image fragment is situated to the right of the image fragment of interest, that is, if the i-th image fragment has coordinates equal to (X2, Y2) and (X4, Y4) of the image fragment of interest, the image processing apparatus goes to Act 1407.

In Act 1407, the image processing apparatus compares the other attribute data of the image fragment of interest and the i-th image fragment. If the difference between the other attribute data of the image fragment of interest and the i-th image fragment is equal to or smaller than a threshold value, the image processing apparatus goes to Act 1408. If the difference is not equal to or smaller than the threshold value, the image processing apparatus returns to Act 1404.

In Act 1408, the image processing apparatus calculates a D-value of the neighboring sides of the image fragment of interest and the i-th image fragment.

In Act 1409, the image processing apparatus determines whether the D-value is smaller than a threshold value T. If the D-value is smaller than the threshold value, the image processing apparatus determines in Act 1410 that the i-th image fragment is neighboring to the image fragment of interest.

The image processing apparatus allocates “A1” as position information to the image fragment of interest. Then, if the i-th image fragment is situated below the image fragment of interest, the image processing apparatus allocates “A2” as position information to the i-th image fragment.

If the i-th image fragment is situated to the right of the image fragment of interest, the image processing apparatus allocates “B1” as position information to the i-th image fragment.

If the i-th image fragment is situated below the image fragment of interest, the image processing apparatus sequentially increases the number on the right as in “A2” and “A3” as position information allocated to the i-th image fragment. Meanwhile, if the i-th image fragment is situated to the right of the image fragment of interest, the image processing apparatus sequentially advances the alphabetic letter on the left as in “B1” and “C1” as position information allocated to the i-th image fragment.

In Act 1411, the image processing apparatus determines whether the counter i reaches the total number of image fragments k. If the counter i reaches the total number of image fragments k, the image processing apparatus allocates a coupled image title, which is a title if the image fragments are reconfigured, to a group of image fragments determined as neighboring to each other, and then ends the processing. If the total number of image fragments k is not reached, the image processing apparatus goes to Act 1412.

In Act 1412, the image processing apparatus sets the i-th image fragment as an image fragment of interest. In Act 1413, the image processing apparatus excludes the (i−1)th image fragment from processing targets and raises a flag associating the (i−1)th image fragment. Then, the image processing apparatus returns to Act 1404.

The image processing apparatus repeats the above processing of Act 1401 to Act 1413 until there is no determination target image fragments left for each coupled image.

FIG. 8 shows an exemplary layout list outputted by the image processing apparatus using the image block selector 301. As shown in FIG. 8, the layout list includes a coupled image title, position information starting with A1, and title of image fragment, for each coupled image. The layout list may also include other information. The layout of the layout list is not limited to the one shown in FIG. 8.

### (Image Block Composer)

FIG. 9 is a view showing a first example of a coupled image outputted by the image processing apparatus using the image block composer 302. As shown in FIG. 9, the image processing apparatus arranges image fragments inputted from the host, in accordance with the layout list.

Of the position information in the layout list, alphabetic letters show the horizontal layout from left to right, and numerals show the vertical layout from top to bottom.

Since the image block 1 of the coupled image A has position information “A1”, the image processing apparatus arranges the image block 1 at the top left position. Since the image block 2 has position information “A2”, the image processing apparatus arranges the image block 2 below the image block 1. That is, the image blocks are arranged in such a manner that the numeric parts of the position information are arrayed in ascending order from top to bottom in the image processing apparatus. The coupled image A is thus reconfigured.

FIG. 10 is a view showing a second example of a coupled image outputted by the image processing apparatus using the image block composer 302.

Since the image block 4 of the coupled image B has position information “A1”, the image processing apparatus arranges the image block 4 at the top left position. Since the image block 5 has position information “B1”, the image processing apparatus arranges the image block 5 to the right of the image block 4. That is, the image blocks are arranged in such a manner that the letter parts of the position information are in ascending order from left to right in the image processing apparatus. The coupled image B is thus reconfigured.

### (Image Characteristic Extractor and Image Processor)

The image characteristic extractor 303 extracts the characteristic quantity of each coupled image. For example, the image characteristic extractor 303 generates a luminance histogram for each coupled image. The luminance histogram is as shown in FIG. 20, which is already described.

The image processor 304 converts input luminance for each coupled image and outputs the converted luminance. The image processor 304 may convert input luminance by using a conversion function as shown in FIG. 21. The output of the image processor 304 is, for example, as shown in FIG. 22.

As shown in FIG. 22, bright parts become brighter and dark parts become darker, thus forming a beautiful image with high contrast.

The image block selector 301 may have the attribute data analyzer 301A that analyzes attribute data. The image processing apparatus can accurately reconfigure a coupled image.

### Third Embodiment

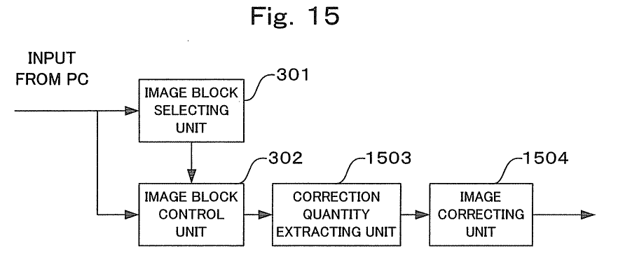

In a third embodiment, the outline of the configuration is similar to that of the first embodiment. FIG. 15 is a block diagram showing a software module for image block selection control carried out by the image processing apparatus. As shown in FIG. 15, this embodiment differs from the first embodiment in that the image processing apparatus has a correction quantity extractor 1503 that extracts the correction quantity for white balance correction, as the image characteristic extractor 303, and an image corrector 1504 that corrects white balance, as the image processor 304.

In the third embodiment, white balance is corrected.

### (Correction Quantity Extractor)

The image processing apparatus extracts a highlight point having the highest luminance in a coupled image by using the correction quantity extractor 1503. A highlight point is likely to be in white.

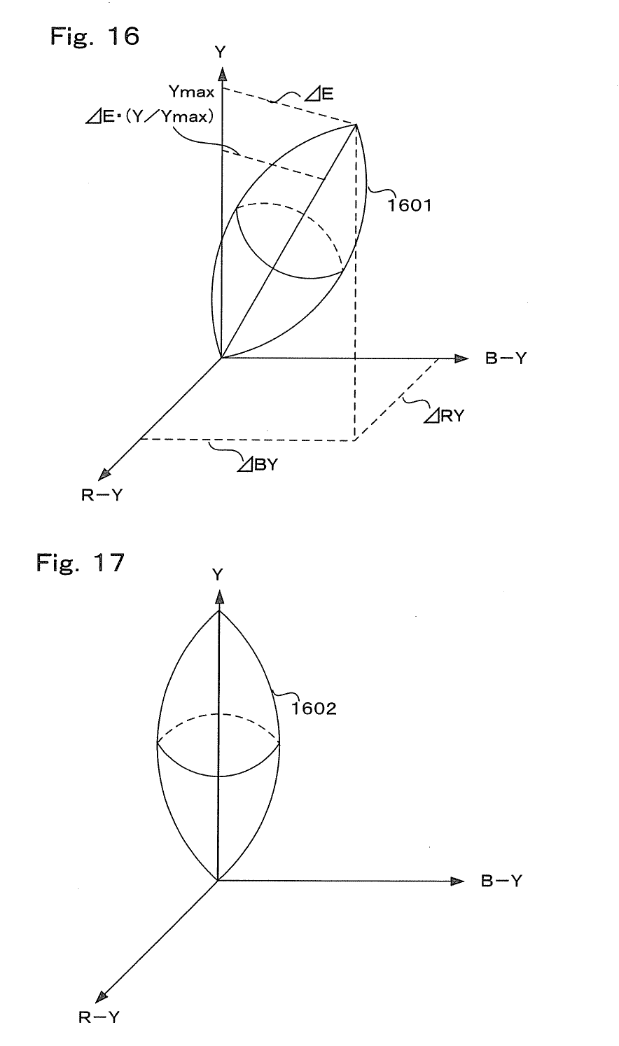

FIG. 16 shows a color solid 1601 at a highlight point. The Y axis represents luminance. The R-Y axis and B-Y axis represent color difference. FIG. 17 shows a color solid 1602 expressing white. White balance correction refers to correcting the color solid 1601 to the color solid 1602.

The image processing apparatus sets a correction quantity ΔE as ΔE (ΔRY, ΔBY), where Ymax represents the luminance of the highlight point and ΔBY and ΔRY represent color difference from white.

### (Image Corrector)

The image processing apparatus corrects the color of each pixel in the following manner by using the image corrector 1504.

(R−Y)′=(R−Y)−ΔRY×(Y/Ymax)

(B−Y)′=(B−Y)−ΔBY×(Y/Ymax)

That is, with respect to arbitrary Y, correction is made by subtracting a component of ΔE×(Y/Ymax).

The image processing apparatus may have the correction quantity extractor 1503 and the image corrector 1504. The image processing apparatus can reconfigure a coupled image and correct white balance.

### Fourth Embodiment

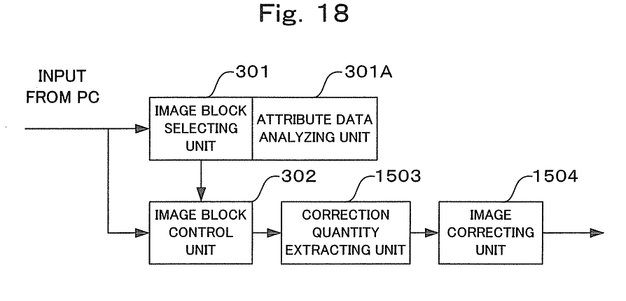

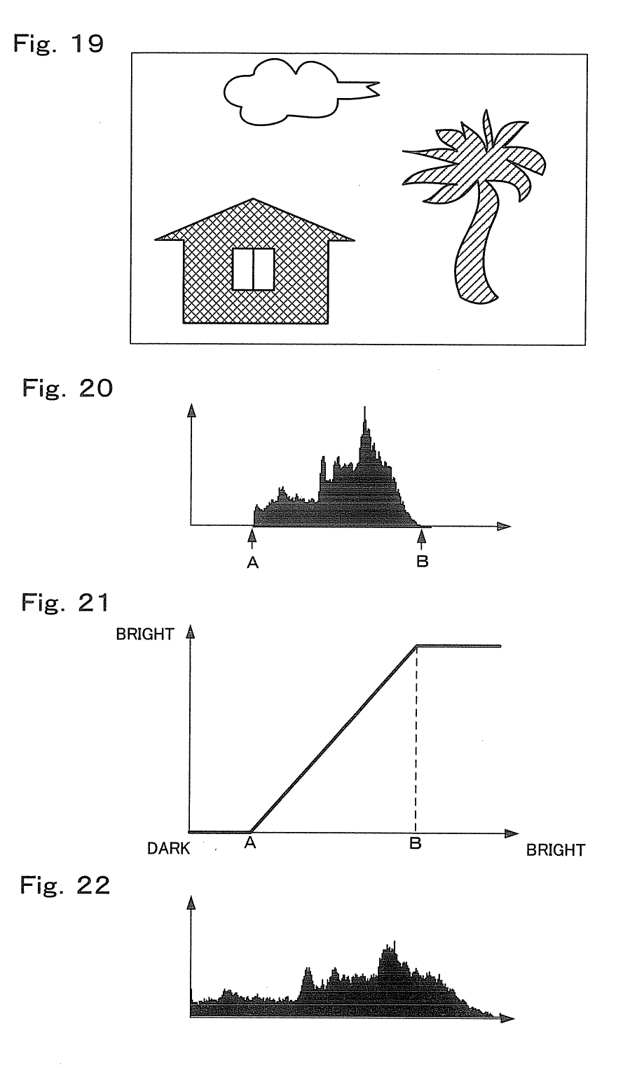

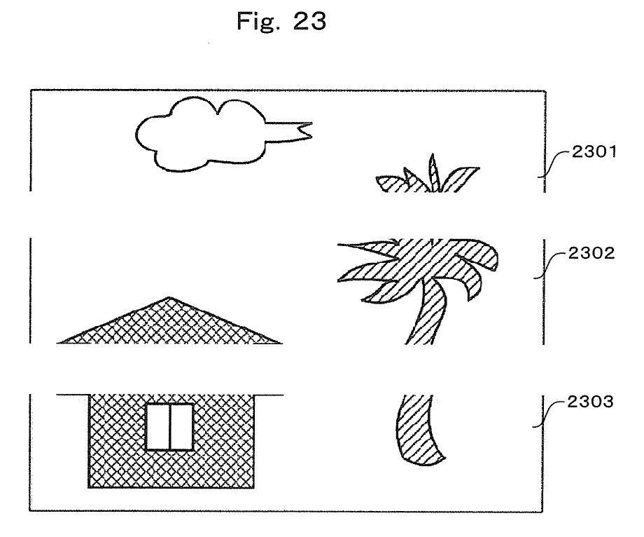

In a fourth embodiment, the outline of the configuration is similar to that of the second embodiment. FIG. 18 is a block diagram showing a software module for image block selection control carried out by the image processing apparatus. As shown in FIG. 18, the fourth embodiment differs from the second embodiment in that the image processing apparatus has a correction quantity extractor 1503 that extracts the correction quantity for white balance correction, as the image characteristic extractor 303, and an image corrector 1504 that corrects white balance, as the image processor 304.

The correction quantity extractor 1503 and the image corrector 1504 are the same as in the third embodiment.

The image block selector 301 may have the attribute data analyzer 301A that analyzes attribute data, and the apparatus has the correction quantity extractor 1503 and the image corrector 1504. The image processing apparatus can accurately reconfigure a coupled image and correct white balance.

Although exemplary embodiments of the invention have been shown and described, it will be apparent to those having ordinary skill in the art that a number of changes, modifications, or alterations to the invention as described herein may be made, none of which departs from the spirit of the invention. All such changes, modifications, and alterations should therefore be seen as within the scope of the invention.

What is claimed is:

1. An image processing apparatus comprising:
an image block selector that receives print data including plurality of image fragments and generates a layout list showing a layout of the plurality of image fragments in a page for the respective page, the plurality of image fragments being parts of a page of original image;
an image block composer that composes the plurality of image fragments to generate a reconfigured image in accordance with the layout list;
an image characteristic extractor that extracts a characteristic quantity with respect to the reconfigured image; and
an image processor that corrects the reconfigured image in accordance with the characteristic quantity to output a corrected image.

2. The apparatus according to claim 1, wherein the image characteristic extractor generates the characteristic quantity as a luminance histogram of the reconfigured image, and
the image processor corrects the histogram to correct the reconfigured image.

3. The apparatus according to claim 2, wherein the image block selector compares size of the plurality of image fragments to determine a neighboring image fragment.

4. The apparatus according to claim 2, wherein the image block selector compares degree of difference in luminance between a neighboring pixel in an image fragment of interest on a neighboring side of the image fragment of interest and a pixel in an image fragment as a determination target, and thereby determines a neighboring image fragment.

5. The apparatus according to claim 2, wherein the image block selector receives print data including plurality of image fragments and attribute data of each image fragment, and generates a layout list showing a layout of the plurality of image fragments in a page for the respective page by using the attribute data, the plurality of image fragments being parts of a page of original image.

6. The apparatus according to claim 5, wherein the image block selector determines whether position information of the attribute data is coincident, and determines a neighboring image fragment.

7. The apparatus according to claim 5, wherein the image block selector compares degree of difference in luminance between a neighboring pixel in an image fragment of interest on a neighboring side of the image fragment of interest and a pixel in an image fragment as a determination target, and thereby determines a neighboring image fragment.

8. The apparatus according to claim 1, wherein the image characteristic extractor extracts luminance of a highlight point in the reconfigured image, as the characteristic quantity, and
the image processor corrects white balance of the reconfigured image, in accordance with the luminance of the highlight point.

9. The apparatus according to claim 8, wherein the image block selector compares size of the image fragment and thereby determines a neighboring image fragment.

10. The apparatus according to claim 8, wherein the image block selector compares degree of difference in luminance between a neighboring pixel in an image fragment of interest on a neighboring side of the image fragment of interest and a pixel in an image fragment as a determination target, and thereby determines a neighboring image fragment.

11. The apparatus according to claim 8, wherein the image block selector receives print data including plurality of image fragments and generates a layout list showing a layout of the plurality of image fragments in a page for the respective page by using the attribute data, the plurality of image fragments being parts of a page of original image.

12. The apparatus according to claim 11, wherein the image block selector determines whether position information of the attribute data is coincident, and determines a neighboring image fragment.

13. The apparatus according to claim 11, wherein the image block selector compares degree of difference in luminance between a neighboring pixel in an image fragment of interest on a neighboring side of the image fragment of interest and a pixel in an image fragment as a determination target, and thereby determines a neighboring image fragment.

14. An image forming apparatus comprising:
an image block selector that receives print data including plurality of image fragments and generates a layout list showing a layout of the plurality of image fragments in a page for the respective page, the plurality of image fragments being parts of a page of original image;
an image block composer that composes the plurality of image fragments to generate a reconfigured image in accordance with the layout list;
an image characteristic extractor that extracts a characteristic quantity with respect to the reconfigured image; and
an image processor that corrects the reconfigured image in accordance with the characteristic quantity to output a corrected image.

15. The apparatus according to claim 14, wherein the image characteristic extractor generates the characteristic quantity as a luminance histogram of the reconfigured image, and
the image processor corrects the histogram to correct the reconfigured image.

16. The apparatus according to claim 15, wherein the image block selector receives print data including the plurality of image fragments and attribute data of each image fragment, and generates a layout list showing a layout of the plurality of image fragments for the respective page by using the attribute data, the plurality of image fragments being parts of a page of original image.

17. The apparatus according to claim 14, wherein the image characteristic extractor extracts luminance of a highlight point in the reconfigured image, as the characteristic quantity, and
the image processor corrects white balance of the reconfigured image, in accordance with the luminance of the highlight point.

18. The apparatus according to claim 17, wherein the image block selector receives print data including the plurality of image fragments and attribute data of each image fragment and generates a layout list showing a layout of the plurality of image fragment for the respective original image by using the attribute data, the plurality of image fragments being parts of a page of original image.

19. An image processing method comprising:
an image processing apparatus receiving print data including plurality of image fragments by using an image block selector, and generating a layout list showing a layout of the plurality of image fragments in a page for the respective page, the plurality of image fragments being parts of a page of original image;
the image processing apparatus reconfiguring the original image in accordance with the layout list by using an image block composer;
the image processing apparatus extracting a characteristic quantity with respect to the reconfigured image, by using an image characteristic extractor; and
the image processing apparatus correcting the reconfigured image in accordance with the characteristic quantity to output a corrected image, by using an image processor.
